(19) United States
(12) Patent Application Publication
(10) Pub. No.: US 2025/0375728 A1
(43) Pub. Date: Dec. 11, 2025

(54) SLIP STREAM CONFIGURATIONS FOR IMPROVED FILTRATION, DIRECT AIR CAPTURE, OR POINT SOURCE CAPTURE

(71) Applicant: Nuxsen LLC, New York, NY (US)

(72) Inventors: Christopher R. Wight, New York, NY (US); Arthur J. Shih, Cambridge, MA (US)

(21) Appl. No.: 19/213,720

(22) Filed: May 20, 2025

Related U.S. Application Data
(60) Provisional application No. 63/657,488, filed on Jun. 7, 2024.

(51) Int. Cl. B01D 53/04

(52) U.S. Cl. CPC B01D 53/0446; B01D 53/0415; B01D 53/0454; B01D 2257/504; B01D 2258/06

(57) ABSTRACT

The disclosure herein relates generally to a filtration system for filtering a stream comprising at least one of a gas, plasma, and liquid. The filtration system includes a plurality of filters, disposed sequentially throughout the filtration system, for filtering a flow of the stream through the filtration system, and at least one conduit disposed between a first filter and second filter of the plurality of filters, the at least one conduit configured to alter the flow of the stream within the filtration system.

### CROSS-REFERENCE TO RELATED APPLICATION

This application claims the benefit of U.S. Provisional Patent Application No. 63/657,488, filed Jun. 7, 2024, which is incorporated by reference herein in its entirety.

### TECHNICAL FIELD

The invention relates to the field of capturing gases, fluids and plasmas.

### BACKGROUND

Direct air capture (DAC) is aimed at capturing carbon dioxide (CO₂) directly from ambient air, which is seen as a crucial tool in combating climate change by reducing atmospheric CO₂ levels. The DAC process typically involves three main steps: air contacting, CO₂ desorption, and CO₂ storage and utilization. During air contacting, ambient air is blown over a sorbent material that selectively captures CO₂. Sorbent filters are essential materials designed to absorb liquids or gases from their surroundings. Sorbent filters can be made up of various materials, including activated carbon, zeolites, silica gels, and clays. The captured CO₂ is then released from the sorbent using heat or chemical reactions, allowing the sorbent to be reused. The concentrated CO₂ can be stored underground through geological sequestration or used in industrial processes, such as producing synthetic fuels.

While DAC can effectively capture and reduce CO₂, Point source capture (PSC) methods can also capturing CO₂ emissions at their source, thereby offering more efficient as reduction of CO₂ emissions as CO₂ concatenations in flue gases are typically higher than in ambient air. PSC can be implemented through various methods, including pre-combustion capture, post-combustion capture, and oxy-fuel combustion. Pre-combustion capture involves removing CO₂ from fuels before combustion. Post-combustion capture captures CO₂ from flue gases after combustion, typically using sorbents. Oxy-fuel combustion burns fuels in pure oxygen, resulting in flue gases that are primarily CO₂ and water vapor, simplifying the capture process.

### SUMMARY

In one example, the disclosure relates to a filtration system for filtering a stream comprising at least one of a gas, plasma, and liquid. The filtration system includes a plurality of filters, disposed sequentially throughout the filtration system, for filtering a flow of the stream through the filtration system, and at least one conduit disposed between a first filter and second filter of the plurality of filters, the at least one conduit configured to alter the flow of the stream within the filtration system.

In another example, the disclosure relates to a capture device comprising a filter housing for filtering a stream comprising at least one of: a gas, plasma, and liquid. The filter housing includes a plurality of filters, disposed sequentially throughout the capture device, for filtering a flow of the stream through the capture device, at least one conduit disposed between a first filter and a second filter of the plurality of filters, the at least one conduit configured to alter the flow of the stream within the capture device, and at least one aperture, disposed in the conduit, for altering the flow by increasing or decreasing the flow of the stream through the capture device.

### BRIEF DESCRIPTION OF DRAWINGS

FIG. 1 is an illustration of a filtration system comprising a slip stream disposed upstream of a blower, according to one example.

FIG. 2 is a s illustration of the filtration system comprising a slip stream disposed downstream of a blower, according to one example.

FIG. 3 is an illustration of the filtration system comprising a first slip stream disposed upstream of a blower and a second slip stream disposed downstream of the blower, according to one example.

FIG. 4 is a schematic of a controller for controlling the filtration system, according to one example.

### DETAILED DESCRIPTION

The descriptions, illustrations, and examples in the present disclosure are given by illustration only and are by no means a limitation. The descriptions, illustrations, and examples are described and discussed in such a way that one skilled in the art may understand and appreciate the principles and practices of the disclosure. Various modifications such as substitutions, additions, rearrangements, may be made that remain potential applications of the disclosed processes.

The disclosure herein relates generally to configurations of parallel cartridges of sorbent interspersed by spacers with adjustable openings. Driven by pressure differences, these openings in the spacers allow fresh gas or fluid to enter (upstream of the blower) and exit (downstream of the blower) and mix with partially treated fluid, enabling the increase in the concentration or partial pressure of the molecule(s) of interest. When a device that imparts kinetic energy to a fluid drives the pressure difference, these spacers may also be used to control the pressure drop and flow rate to modulate and improve performance and energy efficiency.

When moving fluid through a sorbent to capture molecule(s) of interest, the concentration or partial pressure of the molecule(s) of interest decrease through the sorbent bed. This lower concentration results in lower capture rates and capacities, making it more challenging for the sorbent to uptake the molecule(s) of interest, resulting in underutilized portions of the sorbent.

The average concentration of carbon dioxide in the atmosphere has increased from ˜300 ppm to ˜420 ppm over the past few centuries due to the anthropogenic combustion of fossil fuels. This increase in carbon dioxide (CO₂) has been attributed to climate change and increasing prevalence of extreme weather events. To mitigate this, society must not only stop carbon dioxide emissions, but develop technologies to decrease the concentration back to pre-industrial levels.

Carbon capture technologies can capture carbon dioxide directly from carbon dioxide emitting processes (i.e. point source capture), or from diluted ambient sources (i.e. direct air or ocean capture). In point source capture, carbon dioxide is typically captured from process exhaust gases, which often contain carbon dioxide on the order of several percent (several 10000s of ppm). In contrast, direct air capture (DAC) and direct ocean capture (DOC) captures carbon dioxide from the air and ocean, respectively. The atmosphere currently contains around 420 ppm carbon dioxide, approximately 2 to 3 orders of magnitude lower than in point source applications. This difference in carbon dioxide concentrations is responsible for one of the biggest challenges of DAC technologies, resulting in drastically slower carbon dioxide uptake rates and capacities.

Potential technologies to capture carbon dioxide from the atmosphere come in a variety of forms, including membrane separations, physical sorbents, and biological methods. Membrane separations use engineered membranes selectively permeable to carbon dioxide to produce a product stream rich in carbon dioxide. Biological methods typically involve utilizing biological entities with capability to uptake and chemically convert carbon dioxide, such as plants and algae. Physical sorbents can be liquid or solid, and utilize chemicals with affinity to carbon dioxide to adsorb carbon dioxide from the air. The adsorbed carbon dioxide is then desorbed and collected for downstream applications or sequestration. Examples of biological methods include bioengineering plants to uptake more carbon dioxide, then sequestering the dehydrated plants directly or as biochar. Examples of physical sorbents include liquids and slurries, solid metal hydroxides, typically alkali and alkaline-earth hydroxides, solids functionalized with amines, zeolites, metal organic frameworks (MOFs), among others.

After uptake of carbon dioxide, the desorption process can occur continuously with adsorption, resulting in a steady-state process, or as a separate step, resulting in a stepwise cyclical process. Steady-state processes continuously uptakes CO2 at one location in the process while continuously desorbs carbon dioxide in a separate location. Examples of steady-state continuous processes include trickle bed reactors, fluidized bed reactors, slurry aerators, and dual-flow systems. Step-wise cyclical processes are designed to uptake CO2 in one chamber, then desorb CO2 in the same chamber. These systems typically utilize valves or gate-like mechanical processes to isolate and toggle the chamber between adsorption and desorption. Examples of step-wise cyclical processes include mechanical revolvers and simulated moving beds. A number of carbon dioxide desorption strategies have been proposed and studied, including thermal, solar heat, vacuum, steam, electrochemical, microwave, or combinations(s) thereof, among others.

The uptake of carbon dioxide can occur in the presence of naturally produced convection, typically natural wind, or externally produced convection, typically performed with blowers. These blowers are typically used to force carbon dioxide rich gas into the sorbent to displace gas depleted of carbon dioxide. Because increased pressure drop increases the energy and costs required operate the blowers, numerous strategies and designs have been invented to decrease pressure drop. One class of designs involve introducing larger flow paths for the gas to more easily flow such as increasing the sorbent particle size, constructing parallel sheets of thin sorbent, and utilizing monolith blocks. A second class of designs comprise decreasing the thickness of the sorbent bed and increasing its exposed areal surface area by engineering its geometry to zig-zag configurations of sorbent trays and bundles of hollow filters where gas flows radially to or from the center hole.

The disclosed invention presents a method to optimize pressure drops, filtration rates, and filtration capacity by designing a process configuration where streams of fluid, called “slip-streams” may be added to or removed from the process either between two or more sorbent cartridges, or within or at the sorbent cartridges themselves.

In the context of carbon dioxide capture, as a fluid rich in carbon dioxide flows through a sorbent, carbon dioxide is absorbed the sorbent, resulting in a gradual decrease of the concentration of carbon dioxide in the fluid as the fluid penetrates deeper through the bed. This decreased concentration of carbon dioxide not only decreases the carbon dioxide uptake rate, but also reduces its uptake capacity, all while still requiring the same amount of pressure drop and energy to move the carbon dioxide lean fluid through the bed. To mitigate this increased inefficiency at the end of the sorbent cartridge, our disclosed invention increases the carbon dioxide concentration by adding in carbon dioxide rich fluid or removing carbon-dioxide lean fluid from between sorbent cartridges or within/at the sorbent cartridges themselves. This addition or removal of fluid is called a “slip stream”.

When slip stream(s) are added upstream of the blower, the pressure difference draws in the slip stream fluid into the existing fluid flow. Adding slip stream upstream of the blower between or at sorbent cartridges confer a number of advantages, including but not limited to (1) higher CO₂ concentration across large portions of the sorbent, (2) faster CO₂ uptake rate that decreases time to saturation, (3) higher CO₂ uptake capacities, (4) control over residence times of the fluid, (5) use of multiple thinner cartridges conducive for individual replacement, (6) minimize mechanical degradation and attrition of the sorbent, (7) optimization of blower performance, lifetime, and efficiency by modulating the pressure drop and volumetric flow rate.

When slip stream(s) are added downstream of the blower, the pressure difference expels the slip stream fluid from the existing fluid flow. Adding slip stream downstream of the blower between or at sorbent cartridges confer a number of advantages, including but not limited to (1) utilization of the kinetic and pressure energy of the fluid which otherwise would have been lost to the environment to add carbon dioxide capture capacity to the existing system, (2) optimization of air flow to each downstream sorbent cartridge to minimize pressure drop and attrition, and (3) optimization of blower performance, lifetime, and efficiency by modulating the pressure drop and volumetric flow rate.

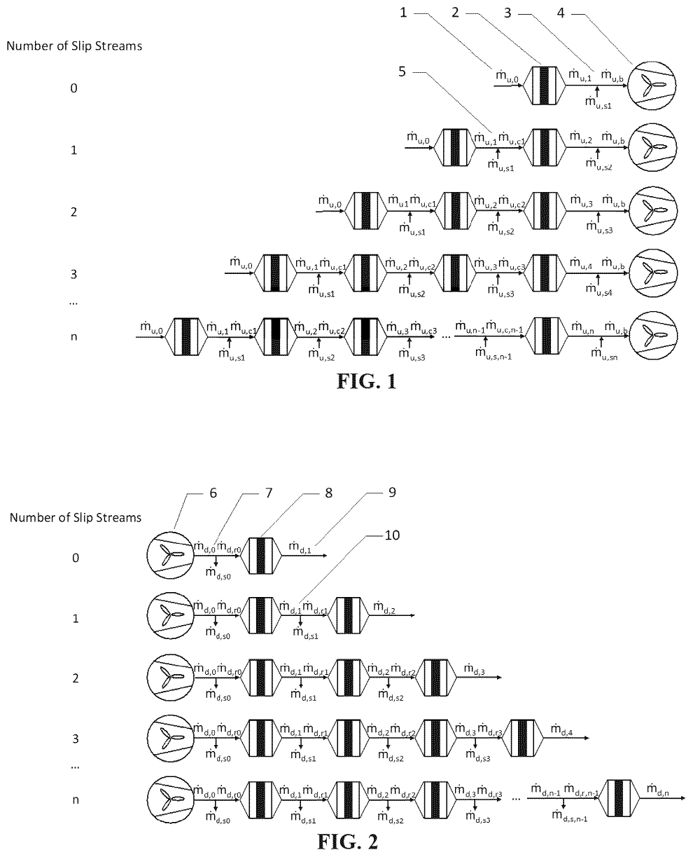

FIG. 1 illustrates an example of an upstream slip stream configuration whereby the slip stream is disposed upstream of a blower. As seen in FIG. 1, any number of slip streams can be added into the fluid flow in between sorbent modules. FIG. 1 includes an inlet fluid stream (1), a sorbent module (2), a slip stream disposed upstream (3) of the input (e.g., a blower/pump (4)), and a slip stream disposed between two sorbent modules (5). \dot{m} represents the mass flow rate of each stream. The subscript u represents “upstream”, s represents the “slip stream”, c represents the combined stream after addition of the slip stream, b represents the stream heading into the blower, and n represent the slip stream number, which are positive integers including 0.

FIG. 2 illustrates an example configuration of a downstream slip stream. Here the slip stream is disposed downstream from a blower. As seen in FIG. 2, any number of slip streams can be added into the fluid flow in between sorbent modules. FIG. 2 includes a blower/pump (6), a slip stream directly downstream (7) of the blower/pump (6), a sorbent module (8), an outlet fluid stream (9), and a slip stream between two sorbent modules (10). \dot{m} represents the mass flow rate of each stream. The subscript d represents “downstream”, s represents the “slip stream”, e represents the final exhaust leaving the configuration to the environment, r represents the remaining stream after removal of fluid from the slip stream, \dot{m}₁ represents the mass flow rate from the blower, and n represent the slip stream number, which are positive integers including 0.

To solve for how different slip stream openings, impact the overall flow dynamics and blower/pump, we utilize the General Mass Balance Equation (Equation 1) and General Energy Balance Equation (Equation 2). In Equation 1 and Equation 2, \dot{m} represents the mass flow rate, \dot{v} represents the flow velocity, \dot{V} represents the volumetric flow rate, A represents the cross sectional area, g represents the gravitational constant, z represents the height, P represents the pressure, ρ represents the fluid density, \dot{Q} represents the addition or removal of heat, Ėᵥ represents frictional losses, and \dot{W}ₛ represents the energy imparted by the blower or pump.

General Mass Balance Equation:

$$\frac{dM}{dt} = {\sum }_{in} {\dot{m}}_{i} - {\sum }_{out} {\dot{m}}_{i} \qquad ( Equation 1 )$$

General Energy Balance Equation:

$$\frac{d}{dt} {E}_{m} = {\sum }_{in} {\dot{m}}_{i} [ \frac{1}{2} {v}_{i}^{2} + {gz}_{i} + \frac{{P}_{i}}{{ρ}_{i}} ] - {\sum }_{out} {\dot{m}}_{i} [ \frac{1}{2} {v}_{i}^{2} + {gz}_{i} + \frac{{P}_{i}}{{ρ}_{i}} ] + \dot{Q} + {\dot{W}}_{s} - {\dot{E}}_{v} \qquad ( Equation 2 )$$

Equation 3 shows the relationship between volumetric flow rate (\dot{V}), fluid velocity (v) and cross-sectional fluid flow area (A). Equation 4 shows the relationship between the mass flow rate (\dot{m}), fluid density (ρ), and volumetric flow rate (\dot{V}). Substituting Equations 3 and 4 into Equation 2 gives us Equation 5, which is a modified form of the General Energy Balance Equation with measurable variables.

$$\dot{V} = vA \qquad ( Equation 3 )$$

$$\dot{m} = ρ \dot{V} \qquad ( Equation 4 )$$

$$\frac{d}{dt} {E}_{m} = {\sum }_{in} {\dot{m}}_{i} [ \frac{1}{2} {( \frac{{\dot{m}}_{i}}{{ρ}_{i} {A}_{i}} )}^{2} + {gz}_{i} + \frac{{P}_{i}}{{ρ}_{i}} ] - {\sum }_{out} {\dot{m}}_{i} [ \frac{1}{2} {( \frac{{\dot{m}}_{i}}{{ρ}_{i} {A}_{i}} )}^{2} + {gz}_{i} + \frac{{P}_{i}}{{ρ}_{i}} ] + \dot{Q} + {\dot{W}}_{s} - {\dot{E}}_{v} \qquad ( Equation 5 )$$

The mass balance equation for the upstream slip stream configuration in FIG. 1 is shown in Equation 6. Equation 6 states that all the mass that flows into the blower (\dot{m}_{u,b}) is equal to the initial mass flowing into the first sorbent cartridge (\dot{m}_{u,0}) plus all of the slip stream flows

$$( {\sum }_{i = 1}^{n} {\dot{m}}_{u , si} ) .$$

When focusing on the molecule(s) of interest to be captured, its fraction, partial pressure, or concentration (f) can be used, as shown in Equation 7. The energy balance equation for the upstream slip stream configuration in FIG. 1 is shown in Equation 8. In Equation 8, the energy imparted by the blower (\dot{W}ₛ) imparts motion and pressure onto all of the entering fluid streams in addition to frictional losses from each sorbent modules

$$( {\sum }_{i = 1}^{n} {\dot{E}}_{sorbent , i} )$$

and when the slip streams are mixed with the main stream

$$( {\sum }_{i = 1}^{n} {\dot{E}}_{tee , i} ) .$$

$$0 = {\dot{m}}_{u , 0} + {\sum }_{i = 1}^{n} {\dot{m}}_{u , si} - {\dot{m}}_{u , b} \qquad ( Equation 6 )$$

$$0 = {f}_{u , 0} {\dot{m}}_{u , 0} + {\sum }_{i = 1}^{n} {f}_{u , si} {\dot{m}}_{u , si} - {f}_{u , b} {\dot{m}}_{u , b} \qquad ( Equation 7 )$$

$$0 = {\dot{m}}_{u , 0} [ \frac{1}{2} {( \frac{{\dot{m}}_{u , 0}}{{ρ}_{fluid} {A}_{u , 0}} )}^{2} + \frac{{P}_{inlet}}{{ρ}_{fluid}} ] + {\sum }_{i = 1}^{n} {\dot{m}}_{u , si} [ \frac{1}{2} {( \frac{{\dot{m}}_{u , si}}{{ρ}_{fluid} {A}_{u , s ,}} )}^{2} + \frac{{P}_{u , si}}{{ρ}_{fluid}} ] - {\dot{m}}_{u , b} [ \frac{1}{2} {( \frac{{\dot{m}}_{u , b}}{{ρ}_{fluid} {A}_{u , b}} )}^{2} + \frac{{P}_{u , b}}{{ρ}_{fluid}} ] - {\sum }_{i = 1}^{n} {\dot{E}}_{tee , i} - {\sum }_{i = 1}^{n} {\dot{E}}_{sorbent , i} + {\dot{W}}_{s} \qquad ( Equation 8 )$$

The mass balance equation for the downstream slip stream configuration in FIG. 2 is shown in Equation 9. Equation 9 states that all the mass that flows out of the blower (\dot{m}_{d,1}) is equal to the mass that flows out of the slip streams

$$( {\sum }_{i = 1}^{n} {\dot{m}}_{d , si} )$$

plus the mass flowing out of the final sorbent cartridge (\dot{m}_{d,e}). The energy balance equation for the upstream slip stream configuration in FIG. 2 is shown in Equation 10. In Equation 10, all of the energy imparted by the blower (\dot{W}ₛ) and of the fluid leaving the blower gets dissipated through slip stream tees

$$( {\sum }_{i = 1}^{n} {\dot{E}}_{tee , i} ) ,$$

through each sorbent module

$$( {\sum }_{i = 1}^{n} {\dot{E}}_{sorbent , i} ) ,$$

and with the fluid leaving through the slip streams and the final sorbent module.

$$0 = {\dot{m}}_{d , 1} - {\sum }_{i = 1}^{n} {\dot{m}}_{d , si} - {\dot{m}}_{d , e} \qquad ( Equation 9 )$$

$$0 = {\dot{m}}_{d , 1} [ \frac{1}{2} {( \frac{{\dot{m}}_{d , 1}}{{ρ}_{fluid} {A}_{d , 1}} )}^{2} + \frac{{P}_{inlet}}{{ρ}_{fluid}} ] - {\sum }_{i = 1}^{n} {\dot{m}}_{d , si} [ \frac{1}{2} {( \frac{{\dot{m}}_{d , si}}{{ρ}_{fluid} {A}_{d , si}} )}^{2} + \frac{{P}_{d , si}}{{ρ}_{fluid}} ] - {\dot{m}}_{d , e} [ \frac{1}{2} {( \frac{{\dot{m}}_{d , e}}{{ρ}_{fluid} {A}_{d , e}} )}^{2} + \frac{{P}_{d , e}}{{ρ}_{fluid}} ] - {\sum }_{i = 1}^{n} {\dot{E}}_{tee , i} - {\sum }_{i = 1}^{n} {\dot{E}}_{sorbent , i} + {\dot{W}}_{s} \qquad ( Equation 10 )$$

Equations 10 and 11 can be added to the system of equations when the process includes both upstream and downstream slip stream components.

$$0 = {\dot{m}}_{u , b} - {\dot{m}}_{d , 1} \qquad ( Equation 11 )$$

$$0 = {\dot{W}}_{s} + {\dot{m}}_{u , b} [ \frac{1}{2} {( \frac{{\dot{m}}_{u , b}}{{ρ}_{fluid} {A}_{u , b}} )}^{2} + \frac{{P}_{u , b}}{{ρ}_{fluid}} ] - {\dot{m}}_{d , 1} [ \frac{1}{2} {( \frac{{\dot{m}}_{d , 1}}{{ρ}_{fluid} {A}_{d , 1}} )}^{2} + \frac{{P}_{inlet}}{{ρ}_{fluid}} ] \qquad ( Equation 12 )$$

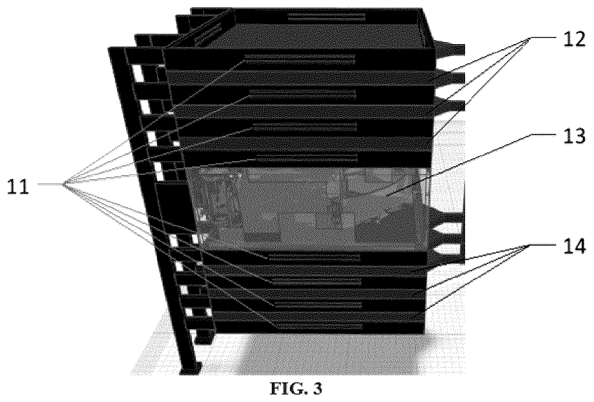

FIG. 3 is an illustration of a filtration system comprising a first slip stream disposed upstream of a blower and a second slip stream disposed downstream of the blower. The filtration system in FIG. 3 includes slip stream apertures (11), sorbent modules disposed upstream (12), sorbent module disposed downstream (14), and a blower/pump (13).

The filtration system configured to filter a stream comprising at least one of: a gas, plasma, and liquid. As illustrated in FIG. 3, a plurality of filters disposed upstream (e.g., along the stream prior to the blower/pump (13)). The filter system also includes a plurality of filters disposed downstream (e.g., along the stream after the blower/pump).

The filtration system further comprising an aperture (e.g., adjustable valve; injector; mister; aperture; dropper; and tablet) for altering the stream by increasing or decreasing the flow of the stream through the filtration system. In one example, flow of the stream can be altered by increasing or decreasing the flow rate of the stream through the system via the aperture. In one example, the aperture is disposed within the conduit, thereby allowing flow of the stream through the conduit to be altered and/or maintained.

The filtration system can also include an aperture for selectively drawing fluid from the stream. In one example, the filtration system includes: (i) a first section comprising a first filter, first conduit, and second conduit; (ii) and a second section comprising a second filter, third conduit, and fourth conduit. The aperture can draw a gas, plasma, and/or liquid from the filtration in a specified amount (e.g., an amount of a gas can be removed from the enclosed filtration system and sampled to determine characteristics of the gas).

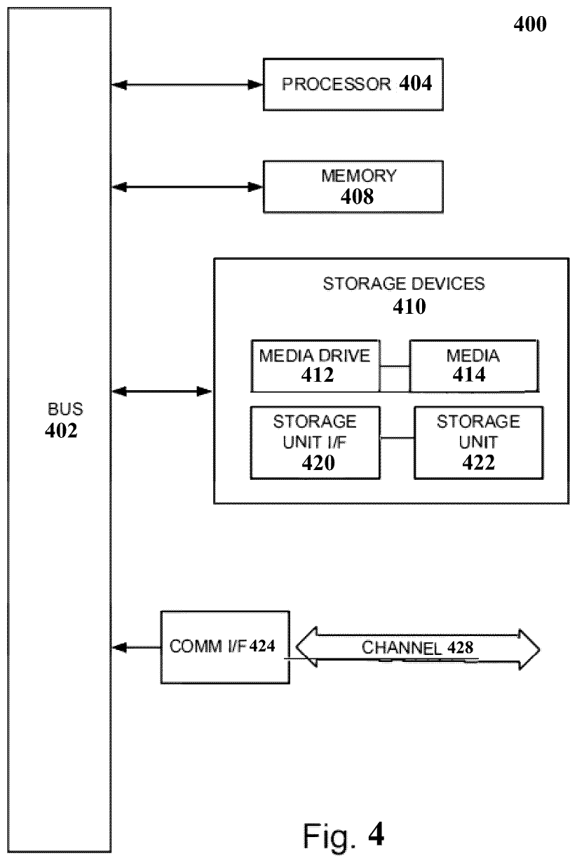

In one example, the filtration system can also include a controller. FIG. 4 is a schematic of an example controller for controlling the filtration system. FIG. 4 includes a controller 400. The controller 400 includes a processor 404. The processor 404 can be implemented using a general-purpose or special-purpose processing engine such as, for example, a microprocessor, controller, or other control logic. The processor 404 can be connected to a bus 402. However, any communication medium can be used to facilitate interaction with other components of controller 400 or to communicate externally with the filtration system.

The controller 400 can also include a main memory 408. The main memory 408 can be random access memory (RAM) or other dynamic memory, might be used for storing information and instructions to be executed by processor. Main memory 408 might also be used for storing temporary variables or other intermediate information during execution of instructions to be executed by processor 404. The controller 400 might likewise include a read only memory (“ROM”) or other static storage device coupled to bus 402 for storing static information and instruction for processor 404.

The controller 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid-state drive, a magnetic tape drive, an optical drive, a compact disc (CD) or digital video disc (DVD) drive (R or RW), or other removable or fixed media drive might be provided. Storage media 414 might include, for example, a hard disk, an integrated circuit assembly, magnetic tape, cartridge, optical disk, a CD or DVD. Storage media 414 may be any other fixed or removable medium that is read by, written to or accessed by media drive 412.

As these examples illustrate, the storage media 414 can include a computer usable storage medium having stored therein computer software or data. In alternative examples, the information storage mechanism 410 might include other similar instrumentalities or allowing computer programs or other instructions or data to be loaded into the controller 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory component) and memory slot. Other examples may include a PCMCIA slot and card, and other fixed or removable storage units 422 and interfaces 420 that allow software and data to be transferred from storage unit 422 to computing component 400.

The controller 400 can also include a communications interface 424. Communications interface 424 might be used to allow software and data to be transferred between the controller 400 and external devices. Examples of communications interface 424 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 424 may be carried on signals, which can be electronic, electromagnetic (which includes optical) or other signals capable of being exchanged by a given communications interface 424. These signals might be provided to communications interface 424 via a channel 428. Channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the controller 400 to perform features or functions of the present application as discussed herein. It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A filtration system for filtering a stream comprising at least one of a gas, plasma, and liquid, the filtration system comprising:
a plurality of filters, disposed throughout the filtration system, for filtering a flow of the stream through the filtration system; and
at least one conduit disposed between a first filter and second filter of the plurality of filters, the at least one conduit configured to alter the flow of the stream within the filtration system.

2. The filtration system of claim 1, wherein the flow is altered by increasing or decreasing a flow rate of the stream throughout the filtration system.

3. The filtration system of claim 1, further comprising an aperture for altering the stream by increasing or decreasing the flow of the stream through the filtration system.

4. The filtration system of claim 3, wherein the aperture comprises at least one of: a adjustable valve; injector; mister; aperture; dropper; and tablet.

5. The filtration system of claim 4, wherein the aperture is configured to alter a concentration of the stream through the filtration system.

6. The filtration system of claim 3, wherein the filtration system is configured to maintain a flow of the stream when one or more filters are removed from the filtration system.

7. The filtration system of claim 3, wherein the filtration system further includes:
a first section comprising a first filter, first conduit, and second conduit; and
a second section comprising a second filter, third conduit, and fourth conduit.

8. The filtration system of claim 7, wherein the filtration system is configured to selectively draw or expel fluid from the first section and second section with or without altering the flow.

9. The filtration system of claim 8, wherein the filtration is further configured to concurrently selectively draw or expel fluid from the first section and second section with or without altering the flow.

10. The filtration system of claim 4, wherein at least one of: a pump, fan and blower is used to alter the flow of the stream through the filtration system.

11. The filtration system of claim 1, wherein dimensions of the conduits are adjustable.

12. A capture device comprising:
a filter housing for filtering a stream comprising at least one of: a gas, plasma, and liquid, the filter housing comprising:
a plurality of filters, disposed throughout the capture device, for filtering a flow of the stream through the capture device;
at least one conduit disposed between a first filter and a second filter of the plurality of filters, the at least one conduit configured to alter the flow of the stream within the capture device; and
at least one aperture, disposed in the conduit, for altering the flow by increasing or decreasing the flow of the stream through the capture device.

13. The capture device of claim 12, wherein the at least one aperture includes at least one of: a electrical component, a heating component, tubing, piping, a valve, sensor, and flow device.

14. The capture device of claim 12, wherein the filter housing comprises at least one of: (i) a mineral material, (ii) ceramic material, (iii) a polymer material, (iv) a biomaterial, (v) metals, (vi) composites thereof.

15. The capture device of claim 12, wherein the filter housing is coupled to at least one of: (i) a capture device, (ii) fan; (iii) filter, (iv) dehumidifier, (v) humidifier, (vi) heat exchanger, (vii) heat pump, (viii) compressor, (ix) vacuum, (x) pump, (xi) blower, and (xi) gas absorber.

16. The capture device of claim 12, further comprising a controller configured to receive input signals to adjust and maintain operation of the capture device.

17. The capture device of claim 16, wherein the input signals include at least one of: (i) temperature, (ii) pressure, (iii) concentration, (iv) flow rate, (v) voltage, and (vi) valve configuration.

18. The capture device of claim 17, wherein the controller is configured to send output signals to adjust and maintain operation of at least one of: (i) a valve, (ii) heater, (iii) fan, (iv) pump, (v) blower, and (vi) compressor.
